(19) United States
(12) Patent Application Publication
(10) Pub. No.: US 2026/0121224 A1
(43) Pub. Date: Apr. 30, 2026

(54) COMPOSITION FOR COATING LAYER, SEPARATOR USING THE SAME, AND ELECTROCHEMICAL DEVICE INCLUDING THE SAME

(71) Applicant: LG ENERGY SOLUTION, LTD., Seoul (KR)

(72) Inventors: Ji Su LEE, Daejeon (KR); Young Mo LEE, Daejeon (KR); Kyung Ryun KA, Daejeon (KR)

(73) Assignee: LG ENERGY SOLUTION, LTD., Seoul (KR)

(21) Appl. No.: 19/366,662

(22) Filed: Oct. 23, 2025

(30) Foreign Application Priority Data
Oct. 24, 2024 (KR) 10-2024-0146486

(51) Int. Cl. H01M 50/446; H01M 10/052; H01M 50/414; H01M 50/434; H01M 50/443; H01M 50/449

(52) U.S. Cl. CPC H01M 50/446; H01M 10/052; H01M 50/414; H01M 50/434; H01M 50/443; H01M 50/449

(57) ABSTRACT

A separator for an electrochemical device of the present disclosure includes: a porous polymer substrate; and a coating layer provided on at least one surface of the porous polymer substrate, and including inorganic particles, a polymer binder, and a dispersant. The coating layer is manufactured by a coating layer composition, the coating layer composition includes inorganic particles, a polymer binder, and a dispersant, and the dispersant includes a maleic acid monomer.

### CROSS-REFERENCE TO RELATED APPLICATIONS

This application is based on and claims priority from Korean Patent Application No. 10-2024-0146486 filed on Oct. 24, 2024, with the Korean Intellectual Property Office, the disclosure of which is incorporated herein in its entirety by reference.

### TECHNICAL FIELD

The present disclosure relates to a coating layer forming composition, a separator using the same, and an electrochemical device including the same.

### BACKGROUND

An electrochemical device converts chemical energy into electrical energy by using electrochemical reactions. In recent years, lithium secondary batteries, which have a high energy density, a high voltage, and a long cycle life and can be used in various fields, are widely being used.

A lithium secondary battery may include an electrode assembly manufactured by a positive electrode, a negative electrode, and a separator disposed between the positive electrode and the negative electrode, and may be manufactured by placing the electrode assembly, together with an electrolyte, in a case.

### SUMMARY

The present disclosure provides a composition for forming a coating layer (a coating layer composition), a separator using the same, and an electrochemical device including the same, in which a dispersant included in a coating layer is controlled to improve the dispersibility and the heat resistance properties.

However, the coating layer composition, the separator using the same, and the electrochemical device including the same of the present disclosure are not limited to the above-mentioned characteristics, and other unmentioned characteristics will be clearly understood by those skilled in the art from the following description.

A coating layer composition provided in one embodiment of the present disclosure includes inorganic particles, a polymer binder, and a dispersant, and the dispersant includes a maleic acid monomer.

The particle size D90 of the coating layer composition may be about 1.5 μm or less.

A separator for an electrochemical device provided in one embodiment of the present disclosure includes: a porous polymer substrate; and a coating layer provided on at least one surface of the porous polymer substrate, and including inorganic particles, a polymer binder, and a dispersant. The dispersant includes a maleic acid monomer.

The thickness of the coating layer may be about 1 μm to 3 μm.

The inorganic particle may be one selected from BaTiO₃, Pb(Zr,Ti)O₃ (PZT), Pb₁₋ₓLaₓZr_{1-y}Ti_{y}O₃ (PLZT, 0<x<1, 0<y<1), Pb(Mg_{1/3}Nb_{2/3})O₃—PbTiO₃ (PMN-PT), hafnia (HfO₂), SrTiO₃, SnO₂, CeO₂, MgO, Mg(OH)₂, NiO, CaO, ZnO, ZrO₂, SiO₂, Y₂O₃, SiC, Al₂O₃, Al(OH)₃, AlO(OH), TiO₂, zinctinhydroxide (ZnSn(OH)₆), tin-zinc oxide (Zn₂SnO₄, ZnSnO₃), antimony trioxide (Sb₂O₃), antimony tetroxide (Sb₂O₄), and antimony pentoxide (Sb₂O₅).

The average particle size of the inorganic particles may be about 0.2 μm to 1.5 μm.

The dispersant may further include a styrene monomer.

The dispersant may include a styrene-maleic acid copolymer (SMA).

The dispersant may further include a polyether chain.

The coating layer may further include a surfactant, and the surfactant may be a polysiloxane-based material.

An electrochemical device provided in one embodiment of the present disclosure includes: a positive electrode; a negative electrode; and the above-described separator interposed between the positive electrode and the negative electrode.

In the coating layer composition according to one embodiment of the present disclosure, since the dispersant includes the maleic acid monomer, the dispersibility may be improved and the coating defects may be minimized.

In the separator for the electrochemical device according to one embodiment of the present disclosure, since the dispersant contained in the coating layer includes a maleic acid monomer, the dispersibility may be improved and the heat resistance properties may be improved.

In the electrochemical device according to one embodiment of the present disclosure, the dispersant contained in the coating layer includes a maleic acid monomer, and thus the dispersibility and heat resistance properties may be improved, thereby improving battery life characteristics.

### BRIEF DESCRIPTION OF THE DRAWINGS

The following drawings attached hereto illustrate embodiments of the present disclosure and serve to further understand the technical idea of the present disclosure together with the detailed description of the disclosure to be described later. Therefore, the present disclosure should not be construed as being limited to the matters illustrated in the drawings.

FIG. 1 is a schematic view of a separator for an electrochemical device according to one embodiment of the present disclosure.

FIG. 2 is a microscopic image from which the presence or absence of separator protrusions was determined for Example 1 according to one embodiment of the present disclosure.

FIG. 3 is a microscopic image from which the presence or absence of separator protrusions was determined for Comparative Example 1 according to one embodiment of the present disclosure.

Corresponding reference characters indicate corresponding components throughout the several views of the drawings. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

In this specification, when it is said that a certain part “includes” a certain component, this means that the certain part may further include other components rather than excluding other components unless specifically stated to the contrary.

In this specification, “A and/or B” means “A and B, or A or B.”

In this specification, “about,” “approximately,” and “substantially” refer to a range of, or approximation to a numerical value or degree, taking into account inherent manufacturing and material tolerances (e.g., ±5%), and are intended to prevent infringers from unfairly taking advantage of the present disclosure that describes precise or absolute numerical values to aid the understanding of the present disclosure.

In this specification, when one component is said to be provided “on” the other component, this does not exclude other components disposed between these, but means that other components may be further disposed unless specifically stated to the contrary.

In this specification, the characteristic of having pores means that the object includes a plurality of pores, and the pores are connected to each other to form a structure that allows gaseous and/or liquid fluid to pass from one side surface to the other side surface of the object.

In this specification, a separator has a porous characteristic including a large number of pores, and serves as a porous ion-conducting barrier that blocks an electrical contact between a negative electrode and a positive electrode in an electrochemical device while allowing ions to pass.

Among the components of an electrochemical device, a separator may include a polymer substrate having a porous structure located between a positive electrode and a negative electrode. The separator plays a role in preventing an electrical short between the positive electrode and the negative electrode by separating two electrodes from each other while playing a role in allowing electrolyte and ions to pass therethrough. Although the separator itself does not participate in an electrochemical reaction, physical properties such as wettability to the electrolyte, porosity, and thermal shrinkage may affect the performance and safety of the electrochemical device.

Therefore, in order to enhance these physical properties of the separator, various methods have been attempted, in which a coating layer is added to a porous polymer substrate, and various materials are added to the coating layer so as to improve the properties of the coating layer. As an example, in order to improve the mechanical strength of the separator, inorganic substances may be added to the coating layer, or inorganic substances or hydrates for improving the flame retardancy and heat resistance of the polymer substrate may be added to the coating layer.

Within the coating layer, inorganic particles may be linked to other inorganic particles by a polymer binder to form an interstitial volume, and lithium ions may move through the interstitial volume. That is, the coating layer containing the polymer binder and the inorganic particles plays a role in assisting the movement of lithium ions through the separator while playing a role in preventing thermal shrinkage of the separator.

Here, when the coating layer is formed, the inorganic particles have to be uniformly distributed so as to minimize defects such as protrusions and non-coating. Then, the heat resistance properties of the separator may be secured due to excellent coating properties.

In consideration of these points, in the coating layer provided in the present disclosure, the dispersibility may be improved during formation of the coating layer, the excellent heat resistance properties may be achieved, and the coating defects may be minimized.

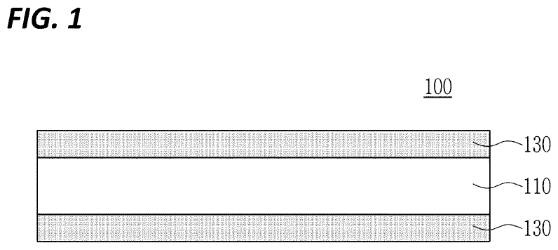

FIG. 1 is a schematic view of a separator for an electrochemical device according to one embodiment of the present disclosure.

Referring to FIG. 1, a separator 100 for an electrochemical device according to one embodiment of the present disclosure includes: a porous polymer substrate 110; and a coating layer 130 provided on at least one surface of the porous polymer substrate 110, and including inorganic particles, a polymer binder, and a dispersant. The dispersant includes a maleic acid monomer.

The coating layer 130 according to one embodiment of the present disclosure is manufactured from a composition for forming a coating layer (a coating layer composition) that includes inorganic particles, a polymer binder, and a dispersant, in which the dispersant includes a maleic acid monomer.

In the coating layer composition according to one embodiment of the present disclosure, since the dispersant includes the maleic acid monomer, the dispersibility is improved and the coating defects are minimized. Then, it is possible to improve the air permeability and resistance of the separator 100 manufactured from this composition.

According to one embodiment of the present disclosure, the particle size D90 of the coating layer composition may be about 1.5 μm or less. For example, the particle size D90 of the coating layer composition may be about 0.5 μm to 1.5 μm, 0.6 μm to 1.5 μm, 0.7 μm to 1.5 μm, 0.8 μm to 1.5 μm, 0.8 μm to 1.4 μm, 0.8 μm to 1.3 μm, 0.8 μm to 1.2 μm, 0.8 μm to 1.1 μm or 0.8 μm to 1 μm. Within the above-described range of the particle size D90, the dispersibility of the coating layer composition is improved, and thus the coating properties of the coating layer 130 to be manufactured and the resistance properties of the separator 100 may be improved. Also, as the coating properties are improved, the occurrence of protrusions on the separator may be suppressed and the coating defects may be reduced. In this way, by controlling the particle size D90 of the coating layer composition within the above-described range, the dispersibility in the coating layer may be improved, and thus the coating properties of the coating layer 130 may be improved, and the air permeability and resistance of the separator 100 may be improved. Also, as the coating properties of the coating layer 130 are improved, the occurrence of protrusions on the separator may be suppressed and the coating defects may be minimized.

According to one embodiment of the present disclosure, the particle size D50 of the coating layer composition may be about 0.3 μm to 1.5 μm. For example, the particle size D50 of the coating layer composition may be about 0.3 μm to 1.4 μm, 0.3 μm to 1.3 μm, 0.3 μm to 1.2 μm, 0.3 μm to 1.1 μm, 0.3 μm to 1 μm, 0.3 μm to 0.9 μm, 0.3 μm to 0.8 μm, 0.3 μm to 0.7 μm, 0.3 μm to 0.6 μm or 0.3 μm to 0.5 μm. When the particle size D50 of the composition is within the above-described range, as described below, the dispersibility of the coating layer composition is improved. Thus, the coating properties of the coating layer 130 may be improved and the increase in resistance of the separator 100 may be suppressed. Also, it is possible to minimize the occurrence of separator protrusions and the coating defects which may occur due to the decrease in coating properties. In this way, by controlling the particle size D50 of the coating layer composition within the above-described range, the dispersibility in the coating layer may be improved, and thus the coating properties may be improved and the air permeability and resistance of the separator 100 may be improved. Also, as the coating properties of the coating layer 130 are improved, the occurrence of protrusions on the separator may be suppressed and the coating defects may be minimized.

In this specification, the “particle sizes D50 and D90” refer to particle sizes at the points of 50% and 90% in the cumulative distribution of the number of particles based on the particle size. The particle size may be measured by using a laser diffraction method. For example, a measurement target is dispersed in a dispersion medium, and then is introduced into a commercially available laser diffraction particle size measurement device (e.g., Microtrac S3500). Then, when the particles pass through laser beam, the particle size distribution is calculated by measuring the difference in the diffraction pattern according to the particle size. The particle sizes D50 and D90 may be measured by calculating the particle diameters at the points of 50% and 90%, respectively, in the cumulative distribution of the number of particles based on the particle size, in the measuring device.

In the separator 100 for the electrochemical device according to one embodiment of the present disclosure, since the dispersant included in the coating layer 130 contains a maleic acid monomer, the dispersibility may be improved and the heat resistance properties may be improved.

According to one embodiment of the present disclosure, the porous polymer substrate 110 may be manufactured using a polyolefin-based resin as a base resin. Examples of the polyolefin-based resin may include polyethylene, polypropylene, and polypentene, and at least one type of these may be included. A porous separator manufactured using the polyolefin-based resin having a large number of pores as a base resin, may provide a shutdown function at an appropriate temperature. The shutdown function is a function that prevents thermal runaway, in which when the battery is overheated, the separator blocks its pores, thereby cutting off the current flow. In this function, when the internal temperature of the battery rises above a certain temperature, the separator melts so that its pores are blocked, thereby blocking the contact between the positive electrode and the negative electrode and stopping the current flow.

According to one embodiment of the present disclosure, the weight average molecular weight of the polyolefin-based resin may be about 500,000 to 1,500,000. By adjusting the weight average molecular weight of the polyolefin-based resin within the above-described range, the compression resistance of the separator may be improved. Furthermore, when a mixture of different types of polyolefin-based resins is used or a separator is formed with a multi-layered structure made of different types of polyolefin-based resins, the weight average molecular weight of the polyolefin-based resin may be calculated by adding up the weight average molecular weights according to the respective content ratios of the polyolefin-based resins.

In this specification, the weight average molecular weight (Mw) may be measured by gel permeation chromatography (GPC, PL GPC220, Agilent Technologies), and in one embodiment, the measurement conditions may be set as follows.
Column: PL Olexis (Polymer Laboratories)
Solvent: TCB (Trichlorobenzene)
Flow rate: 1.0 ml/min
Sample concentration: 1.0 mg/ml
Injection volume: 200 μl
Column Temperature: 160° C.
Detector: Agilent High Temperature RI detector
Standard: Polystyrene (corrected by a cubic function)

According to one embodiment of the present disclosure, in the (wet) method of manufacturing the porous polymer substrate 110, a polyolefin-based resin may be mixed with a diluent at high temperatures to form a single phase, and phase-separation between the polymer material and the diluent may be induced in the cooling process, and then the diluent may be extracted to form pores and subsequently, stretching and heat-setting may be performed.

According to one embodiment of the present disclosure, in the manufacturing, the mixing ratio of the diluent, the stretching ratio, the heat-setting temperature, etc. may be easily controlled by a person skilled in the art so that the average pore size and the maximum pore size of the porous polymer substrate 110 fall within the ranges of the present disclosure.

According to one embodiment of the present disclosure, the thickness of the porous polymer substrate 110 may be about 8 μm to 15 μm. For example, the thickness of the porous polymer substrate 110 may be about 8 μm to 14 μm, 8 μm to 13 μm, 8 μm to 12 μm, 8 μm to 11 μm, or 9 μm to 11 μm, or may be about 10 μm in one embodiment. By controlling the thickness of the porous polymer substrate 110 within the above-described range, it is possible to improve the energy density of the battery.

According to one embodiment of the present disclosure, the thickness of the porous polymer substrate 110 may be measured by using, for example, a thickness measuring device (Mitutoyo corporation, VL-50S-B) through a contact-type measurement method.

According to one embodiment of the present disclosure, the coating layer 130 is provided on at least one surface of the porous polymer substrate 110. As described above, since the separator 100 for the electrochemical device includes the coating layer 130 provided on at least one surface of the porous polymer substrate 110, the heat resistance of the separator may be improved, the mechanical properties may be improved, and the separator may be prevented or suppressed from shrinking at high temperatures and causing an electrical short-circuit in the electrode.

According to one embodiment of the present disclosure, the thickness of the coating layer 130 may be about 1 μm to 3 μm. Within the above-described range of the thickness, the heat resistance of the coating layer 130 may be improved and the uniformity of the coating may be maintained. Also, the air permeability of the coating layer 130 and the resistance of the separator 100 are reduced, and the thickness of the entire separator 100 is reduced, thereby positively affecting the battery assembly process.

In one embodiment of the present disclosure, the thicknesses of the coating layer 130, etc. may be measured by employing a contact-type thickness measuring device. As for the contact-type thickness measuring device, for example, VL-50S-B of Mitutoyo corporation may be used.

According to one embodiment of the present disclosure, the coating layer 130 includes inorganic particles, a polymer binder, and a dispersant. As described above, since the coating layer 130 includes the inorganic particles, the polymer binder, and the dispersant, the heat resistance of the separator is improved, and the mechanical properties are improved, so that the separator 100 is prevented from shrinking at high temperatures and causing an electrical short-circuit in the electrode. Also, pores may be formed inside the coating layer 130, and the dispersibility of the inorganic particles is improved so that the inorganic particles may be uniformly distributed in the coating layer 130 and the coating defects may be minimized.

According to one embodiment of the present disclosure, the coating layer 130 may be formed by the inorganic particles being bound by the polymer binder and accumulated within the layer. The pores within the coating layer 130 may be derived from the interstitial volumes that are empty spaces between the inorganic particles.

According to one embodiment of the present disclosure, the coating layer 130 may include a plurality of pores. For example, the coating layer 130 may be a porous coating layer 130 including a plurality of pores therein. As described above, since the coating layer 130 includes the plurality of pores, lithium ions are allowed to pass through and then current is allowed to flow while a negative electrode and a positive electrode are physically blocked from each other.

According to one embodiment of the present disclosure, the inorganic particles may not undergo oxidation and/or reduction reactions in the operating voltage range (e.g., 0 V to 5 V based on Li/Li⁺) in the application to an electrochemical device.

According to one embodiment of the present disclosure, the inorganic particle may be one selected from BaTiO₃, Pb(Zr,Ti)O₃ (PZT), Pb₁₋ₓLaₓZr_{1-y}Ti_{y}O₃ (PLZT, 0<x<1, 0<y<1), Pb(Mg_{1/3}Nb_{2/3})O₃—PbTiO₃(PMN-PT), hafnia (HfO₂), SrTiO₃, SnO₂, CeO₂, MgO, Mg(OH)₂, NiO, CaO, ZnO, ZrO₂, SiO₂, Y₂O₃, SiC, Al₂O₃, Al(OH)₃, boehmite (AlO(OH)), TiO₂, zinc tin hydroxide (ZnSn(OH)₆), tin-zinc oxide (Zn₂SnO₄, ZnSnO₃), antimony trioxide (Sb₂O₃), antimony tetroxide (Sb₂O₄), and antimony pentoxide (Sb₂O₅). By selecting the above-described type of inorganic particles, the heat resistance of the coating layer 130 may be secured.

According to one embodiment of the present disclosure, the inorganic particle may be one selected from aluminum hydroxide (Al(OH)₃), alumina (Al₂O₃), and boehmite (AlO(OH)). As described above, by selecting one from aluminum hydroxide (Al(OH)₃), alumina (Al₂O₃), and boehmite (AlO(OH)) as for the inorganic particle, the heat resistance of the coating layer 130 may be secured.

According to one embodiment of the present disclosure, the inorganic particle may be alumina (Al₂O₃) and/or boehmite (AlO(OH)). As described above, selecting alumina (Al₂O₃) and/or boehmite (AlO(OH)) as for the inorganic particle enables an interaction with the dispersant in the coating layer 130 as described below. Then, the dispersibility in the coating layer 130 may be improved, thereby improving the coating properties and air permeability of the coating layer 130 and improving the resistance of the separator 100.

According to one embodiment of the present disclosure, the boehmite (AlO(OH)) may be cubic and/or platelet. For example, the cubic boehmite may have a three-dimensionally symmetrical shape and a uniform crystal structure in all directions. The cubic boehmite may have a relatively low specific surface area and a high density, and may be structurally stable. The platelet boehmite may have a two-dimensional structure that is thin and wide-spread, and may be in the form of platelet particles. The platelet boehmite may have a relatively high specific surface area. As described above, when the inorganic particles contain boehmite, it is possible to ensure the uniformity, the increased surface area, and the thermal stability of the coating layer.

According to one embodiment of the present disclosure, the boehmite may be cubic boehmite. As described above, selecting cubic boehmite as for the boehmite may contribute to the structural stability of the coating layer and to the improvement of the resistance.

According to one embodiment of the present disclosure, the inorganic particles may be boehmite (AlO(OH)). For example, as described below, the boehmite (AlO(OH)) can form hydrogen bonds with the dispersant of the present disclosure, and thus may be advantageous for interaction, and further may be more advantageous for dispersion.

According to one embodiment of the present disclosure, the content of the inorganic particles may be about 90 parts by weight to 99 parts by weight based on 100 parts by weight of the coating layer 130. For example, the content of the inorganic particles may be about 91 parts by weight to 99 parts by weight, 92 parts by weight to 99 parts by weight, 92 parts by weight to 98 parts by weight, 92 parts by weight to 97 parts by weight, 92 parts by weight to 96 parts by weight, 92 parts by weight to 95 parts by weight, or 92 parts by weight to 94 parts by weight, based on 100 parts by weight of the coating layer 130. Within the above-described range of the content of the inorganic particles, the heat resistance may be improved. Also, an appropriate polymer binder content may be maintained so that the adhesive strength between inorganic particles may be maintained at an appropriate level, and the possibility of detachment of the coating layer 130 may be reduced. Accordingly, by controlling the content of the inorganic particles included in the coating layer 130 within the above-described range, the heat resistance of the separator may be improved, thereby ensuring the safety of the battery.

According to one embodiment of the present disclosure, the average particle size of the inorganic particles may be about 0.2 μm to 1.5 μm. For example, the average particle size of the inorganic particles may be about 0.2 μm to 1.4 μm, 0.2 μm to 1.3 μm, 0.2 μm to 1.2 μm, 0.2 μm to 1.1 μm, 0.2 μm to 1.0 μm, 0.3 μm to 0.9 μm, 0.4 μm to 0.8 μm, 0.4 μm to 0.7 μm, or 0.4 μm to 0.6 μm. By controlling the average particle size of the inorganic particles within the above-described range, it is possible to control the thickness of the coating layer 130 within an appropriate range while securing the heat resistance.

According to one embodiment of the present disclosure, the polymer binder may be polyacrylic acid, polyacrylamide, polyimide, polyvinyl alcohol, poly hydroxyethyl methacrylate, polyvinylpyrrolidone, polysiloxane, carboxymethylcellulose, polymethylmethacrylate, styrene butadiene rubber, a polyvinylidene-based polymer, or a combination thereof. The combination of the binders may be a mixture of polymer binders, a copolymer including polymer repeating units or a hybridized binder. For example, the polymer binder may be a copolymer of polyacrylic acid and polyacrylamide. By selecting the polymer binder from those described above, it is possible to maintain the porosity of the separator 100, and to improve the bonding force within the coating layer 130 and the adhesive strength between the coating layer 130 and the porous substrate 110. Then, the separator 100 may be easily manufactured, and the winding and stacking process required for manufacturing an electrode assembly may be stably implemented.

According to one embodiment of the present disclosure, the content of the polymer binder may be about 1 parts by weight to 30 parts by weight based on 100 parts by weight of the coating layer 130. For example, the content of the polymer binder may be about 2 parts by weight to 15 parts by weight, 2 parts by weight to 14 parts by weight, 2 parts by weight to 12 parts by weight, 3 parts by weight to 10 parts by weight, 3 parts by weight to 9 parts by weight, 3 parts by weight to 8 parts by weight or 5 parts by weight to 7 parts by weight, based on 100 parts by weight of the coating layer 130. By controlling the content of the polymer binder within the above-described range, it is possible to improve the bonding force with the inorganic particles in the coating layer 130 and the dispersibility of the inorganic particles.

According to one embodiment of the present disclosure, the dispersant includes a maleic acid monomer. For example, the dispersant including the maleic acid monomer may be one selected from styrene-maleic acid copolymer (SMA), ethylene-maleic acid copolymer (EMA), butadiene-maleic acid copolymer (BMA), methyl vinyl ether-maleic acid copolymer (MVE/MA), and acrylic acid-maleic acid copolymer. As described above, the dispersant includes a reactive functional group, such as a carboxyl group (—COOH), by including the maleic acid monomer. Then, it is possible to improve the dispersibility of the inorganic particles through a chemical interaction with the inorganic particles.

According to one embodiment of the present disclosure, the dispersant may further include a styrene monomer. As described above, the dispersant includes a hydrophobic aryl group by further including the styrene monomer. Then, it is possible to form a stable bond in a hydrophobic environment.

According to one embodiment of the present disclosure, the dispersant may include a styrene-maleic acid copolymer (SMA). As described above, when the dispersant includes the styrene-maleic acid copolymer (SMA), a chemical interaction with the inorganic particles is possible due to the carboxyl group (—COOH), i.e., the reactive functional group, included in the maleic acid portion, and a stable bond is formed in a hydrophobic environment due to the hydrophobic aryl group included in the styrene portion. Thus, the dispersibility may be improved.

According to one embodiment of the present disclosure, the dispersant may further include a polyether chain. For example, the dispersant may be obtained by bonding a polyether chain to a styrene-maleic acid copolymer (SMA). The polyether chain may be composed of a chain made of hydrophilic ethylene oxide or propylene oxide, and the hydrophilic chain may increase the hydrophilicity of the dispersant, and improve the dispersion capacity in water or other polar solvents.

According to one embodiment of the present disclosure, the polyether chain may be bonded to the maleic acid portion of the styrene-maleic acid (SMA) copolymer through an esterification reaction with the carboxyl group. Here, the polyether chain may be attached to a main chain of the styrene-maleic acid (SMA) copolymer, in the form of a branch.

According to one embodiment of the present disclosure, the dispersant may be a polyether-modified styrene-maleic acid dispersant. As described above, when the polyether-modified styrene-maleic acid dispersant is selected as the dispersant, the styrene-maleic acid structure may be strongly bonded to the particle surface while the polyether chain may interact with a solvent. Thus, a stable colloid may be formed, thereby preventing or suppressing aggregation between particles and maintaining a uniformly dispersed state.

According to one embodiment of the present disclosure, the content of the dispersant may be about 0.01 to 10 based on 100 parts by weight of the coating layer 130. For example, the content of the dispersant may be about 0.1 to 2, 0.2 to 1.5, 0.3 to 1, 0.3 to 0.8, 0.3 to 0.7 or 0.4 to 0.6 based on 100 parts by weight of the coating layer 130. By controlling the content of the dispersant within the above-described range, inorganic materials in the coating layer 130 may be dispersed. Then, it is possible to improve the dispersibility and to improve the coating properties in the coating layer 130.

According to one embodiment of the present disclosure, the coating layer 130 may further include a surfactant. As described above, when the coating layer 130 further includes the surfactant, the uniformity of the coating layer 130 may be improved and the wettability may be improved.

According to one embodiment of the present disclosure, the surfactant may be a polysiloxane-based material. The polysiloxane is chemically very stable, and thus may have an increased resistance to various chemical substances such as acids, bases, and organic solvents, while maintaining its physical properties well even at high temperatures and having high flexibility. As described above, when the polysiloxane-based surfactant is selected, the uniformity of the coating layer may be improved and the wettability may be improved, and then the chemical resistance may be improved so that the coating layer may function stably even under extreme environments. Also, the polysiloxane-based surfactant may improve the heat resistance of the coating layer 130 of the separator 100, and contribute to improving the mechanical properties of the separator 100 by playing a role in preventing or suppressing cracks or damage of the coating layer 130.

According to one embodiment of the present disclosure, the surfactant may further include a polyether chain. As described above, when the surfactant further includes the polyether chain, the balance between hydrophilicity and hydrophobicity may be controlled.

According to one embodiment of the present disclosure, the content of the surfactant may be about 0.01 to 10 based on 100 parts by weight of the coating layer 130. For example, the content of the surfactant may be about 0.1 to 2, 0.2 to 1.5, 0.3 to 1, 0.3 to 0.8, 0.3 to 0.7 or 0.4 to 0.6 based on 100 parts by weight of the coating layer 130. By controlling the content of the surfactant within the above-described range, it is possible to improve the uniformity of the coating layer 130 and to improve the wettability.

According to one embodiment of the present disclosure, the process of manufacturing the separator 100 may include the steps of: forming the porous polymer substrate 110; forming the coating layer 130 by applying a slurry composition for forming the coating layer (a slurry composition) to at least one surface of the porous polymer substrate 110, the slurry composition containing inorganic particles, a polymer binder, and a dispersant; and drying the coated separator. The porous polymer substrate 110, the inorganic particles, the polymer binder, the dispersant, and the coating layer 130 are the same as described above.

According to one embodiment of the present disclosure, as for a method of coating the porous polymer substrate 110 with the slurry composition, a conventional coating method may be used. For example, various methods such as bar coating, dip coating, die coating, roll coating, comma coating or a mixed method thereof may be used.

One embodiment of the present disclosure includes an electrochemical device that includes: a positive electrode; a negative electrode; and the above-described separator 100 interposed between the positive electrode and the negative electrode. In the electrochemical device according to one embodiment of the present disclosure, the contents overlapping with the description for the separator 100 for the electrochemical device will be omitted.

In the electrochemical device according to one embodiment of the present disclosure, the dispersant contained in the coating layer 130 includes a maleic acid monomer, and thus the dispersibility and heat resistance properties may be improved, thereby improving battery life characteristics.

In one embodiment of the present disclosure, the electrochemical device is a device that converts chemical energy into electrical energy through an electrochemical reaction, and has a concept that encompasses a primary battery and a secondary battery. In this specification, the secondary battery is chargeable and dischargeable, and refers to a lithium secondary battery, a nickel-cadmium battery, a nickel-hydrogen battery, etc. The lithium secondary battery uses lithium ions as an ion conductor. Examples thereof may include a non-aqueous electrolyte secondary battery including a liquid electrolyte, a solid-state battery including a solid electrolyte, a lithium polymer battery including a gel polymer electrolyte, and a lithium metal battery using a lithium metal as a negative electrode, but are not limited to these.

According to one embodiment of the present disclosure, the positive electrode includes a positive electrode current collector, and a positive electrode active material layer on at least one surface of the current collector. The positive electrode active material layer includes a positive electrode active material, a conductive material, and a binder resin. The positive electrode active material may include one type or a mixture of two or more types among layered compounds such as lithium manganese composite oxide (LiMn₂O₄, LiMnO₂, etc.), lithium cobalt oxide (LiCoO₂), and lithium nickel oxide (LiNiO₂) or compounds substituted with one or more transition metals; lithium manganese oxide such as chemical formulas Li₁₊ₓMn₂₋ₓO₄ (where x is 0 to 0.33), LiMnO₃, LiMn₂O₃, and LiMnO₂; lithium copper oxide (Li₂CuO₂); vanadium oxide such as LiV₃O₈, LiV₃O₄, V₂O₅, and Cu₂V₂O₇; Ni site-type lithium nickel oxide represented by a chemical formula LiNi₁₋ₓMₓO₂ (where M=Co, Mn, Al, Cu, Fe, Mg, B or Ga, and x=0.01 to 0.3); lithium manganese composite oxide represented by a chemical formula LiMn₁₋ₓMₓO₂ (where M=Co, Ni, Fe, Cr, Zn or Ta, and x=0.01 to 0.1) or Li₂Mn₃MO₈ (where M=Fe, Co, Ni, Cu or Zn); LiMn₂O₄ in which a part of Li in the chemical formula is substituted with an alkaline earth metal ion; a disulfide compound; and Fe₂(MoO₄)₃.

According to one embodiment of the present disclosure, the negative electrode includes a negative electrode current collector and a negative electrode active material layer on at least one surface of the current collector. The negative electrode active material layer includes a negative electrode active material, a conductive material, and a binder resin. The negative electrode may include, as for the negative electrode active material, one type or a mixture of two or more types selected from lithium metal oxides; carbon such as non-graphitizable carbon, or graphite-based carbon; metal composite oxides such as LixFe₂O₃ (0≤x≤1), LiₓWO₂ (0≤x≤1), and SnₓMe₁₋ₓMe′_{y}O_{z} (Me: Mn, Fe, Pb, Ge; Me′: Al, B, P, Si, elements of groups 1, 2, and 3 of the periodic table, halogen; 0≤x≤1; 1≤y≤3; 1≤z≤8); lithium metal; lithium alloys; silicon-based alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; Li—Co—Ni-based materials; and titanium oxide.

According to one embodiment of the present disclosure, the conductive material may be any one selected from, for example, graphite, carbon black, carbon fiber or metal fiber, metal powder, conductive whiskers, conductive metal oxide, activated carbon, and polyphenylene derivatives, or a mixture of two or more types of conductive materials among these. More specifically, the conductive material may be one type selected from natural graphite, artificial graphite, super-p, acetylene black, Ketjen black, channel black, furnace black, lamp black, thermal black, Denka black, aluminum powder, nickel powder, zinc oxide, potassium titanate, and titanium oxide, or a mixture of two or more types of conductive materials among these.

According to one embodiment of the present disclosure, the current collector is not particularly limited as long as it has high conductivity without causing chemical changes in the corresponding battery. For example, stainless steel, copper, aluminum, nickel, titanium, calcined carbon, or aluminum or stainless steel whose surface is treated with carbon, nickel, titanium, silver, and the like, may be used.

According to one embodiment of the present disclosure, as for the binder resin, a polymer commonly used for electrodes in the art may be used. Non-limiting examples of this binder resin may include polyvinylidene fluoride-co-hexafluoropropylene, polyvinylidene fluoride-cotrichloroethylene, polymethylmethacrylate, polyethylhexyl acrylate, polybutylacrylate, polyacrylonitrile, polyvinylpyrrolidone, polyvinylacetate, polyethylene-co-vinyl acetate, polyethylene oxide, polyarylate, cellulose acetate, cellulose acetate butyrate, cellulose acetate propionate, cyanoethylpullulan, cyanoethylpolyvinylalcohol, cyanoethylcellulose, cyanoethylsucrose, pullulan, and carboxyl methyl cellulose, and are not limited to these.

According to one embodiment of the present disclosure, a positive electrode slurry for preparing the positive electrode active material layer may contain a dispersant. The dispersant may be a pyrrolidone-based compound, and may be, for example, N-methylpyrrolidone (ADC-01, LG chemical).

According to one embodiment of the present disclosure, the electrochemical device may further include an electrolyte, and the electrolyte includes a salt having a structure such as A⁺B⁻, which may be dissolved or dissociated in an organic solvent, but the present disclosure is not limited thereto. A⁺ may include alkali metal cations such as Li⁺, Na⁺, and K⁺ or ions composed of combinations thereof. Also, B⁻ may include anions such as PF₆⁻, BF₄⁻, Cl⁻, Br⁻, I⁻, ClO₄⁻, AsF₆⁻, CH₃CO₂⁻, CF₃SO₃⁻, N(CF₃SO₂)₂⁻, and C(CF₂SO₂)₃⁻ or ions composed of combinations thereof. The organic solvent includes propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone (NMP), ethyl methyl carbonate (EMC), gamma butyrolactone or a mixture thereof.

According to one embodiment of the present disclosure, a battery module including a battery including the electrochemical device as a unit cell, a battery pack including the battery module, and a device including the battery pack as a power source may be provided. Examples of the device may include: a power tool powered and driven by an electric motor; electric cars including an electric vehicle (EV), a hybrid electric vehicle (HEV), a plug-in hybrid electric vehicle (PHEV), and the like; electric two-wheeled vehicles including an electric bicycle (E-bike), and an electric scooter (E-scooter); an electric golf cart; and a power storage system, but are not limited thereto.

Hereinafter, the present disclosure will be described in detail with reference to Examples. However, Examples according to the present disclosure may be modified in various different forms, and the scope of the present disclosure is not construed as being limited to Examples described below. Examples of the present specification are provided to more completely illustrate the present disclosure, to those having average knowledge in the art.

### Example 1

### Manufacturing of Porous Polymer Substrate

A porous polymer substrate (the total thickness: about 10 μm, porosity: 55%, air permeability: 60 s/100 cc, ER: 0.45 ohm) was manufactured by extruding polyethylene resin (weight average molecular weight: 1,000,000) through a wet method.

### Formation of Coating Layer

Boehmite (KB-05S, KC) having a particle size D50 of 0.5 μm was prepared as inorganic particles. As for a polymer binder, a polyacrylic acid-poly acrylamide copolymer having a mass average molecular weight of 100,000 g/mol (poly(acrylic acid)solution, Sigma-Aldrich) was prepared, as for a dispersant, polyether-modified styrene-maleic acid (BYK-ET-3031, BYK) was prepared, and as for a surfactant, polyether-modified polysiloxane (BYK-348, BYK) was prepared.

The prepared inorganic particles, the polymer binder, the dispersant, and the surfactant were added to water at a weight ratio of 93:6:0.5:0.5, and then were stirred to prepare a slurry composition with a solid content of 30%, and a viscosity of 50 cPs.

Here, in the slurry composition, the particle size D50 was 0.38 μm, and the D90 was 0.91 μm.

The slurry composition was applied to both surfaces of the porous polymer substrate by a bar-coating method using a doctor blade, and was dried in wind at 50° C. by using a heat gun so that each coating layer was formed with a thickness of 1.5 μm.

### Example 2

A separator was prepared in the same manner as in Example 1 except that alumina (Al₂O₃, AES11, Sumitomo) with a particle size D50 of 0.5 μm was used as the inorganic particles in Example 1, and the particle size D50 of the slurry composition was 0.42 μm, and the D90 was 0.86 μm.

### Example 3

A separator was prepared in the same manner as in Example 1 except that the thickness of each coating layer was 2 μm in Example 1.

### Example 4

A separator was prepared in the same manner as in Example 1 except that the thickness of each coating layer was 3 μm in Example 1.

### Comparative Example 1

A separator was prepared in the same manner as in Example 1 except that in Example 1, a PAA-based dispersant (K-702, Lubrizol Corporation) was used as the dispersant, the particle size D50 of the slurry composition was 2.14 μm, the D90 was 5.73 μm, and here, the thickness of each coating layer was 2.2 μm.

### Comparative Example 2

A separator was prepared in the same manner as in Example 1 except that in Example 1, the thickness of each coating layer was 4 μm.

### Comparative Example 3

A separator was prepared in the same manner as in Example 1 except that in Example 1, sodium carboxymethyl cellulose (CMC-Na) was used as the dispersant.

### Experimental Example

### Measurement of Particle Sizes D50 and D90

The coating layer composition of Examples and Comparative Examples was introduced into a laser diffraction particle size measuring device (Microtrac S3500). Then, when particles pass through laser beam, the difference in the particle size-based diffraction pattern was measured, and then particle sizes D50 and D90 were measured at points of 50% and 90% in the cumulative distribution of the number of particles.

### Resistance Measurement

The separator of Examples and Comparative Examples was cut and stacked in a 2032 coin cell of Hoshen. Then, when the separator was soaked in an electrolyte, the resistance was measured. This resistance value was obtained by using an electrolyte containing 1 M of LiPF₆ in ethylene carbonate/ethylmethyl carbonate (weight ratio: 3:7) through an alternating current method at 25° C. with electrochemical impedance spectroscopy (EIS).

### Air Permeability Measurement

For the separators of Examples and Comparative Examples, as the air permeability, the time (s) required for 100 cc of air to pass through a separator (diameter: 28.6 mm, area: 645 mm²) was measured by using a Gurley densometer (Gurley, 4110N).

### Measurement of Number of Separator Protrusions

The separators of Examples and Comparative Examples were observed by an optical microscope, and the number of protrusions with a diameter of 1.5 μm or more per unit area (m²) was measured.

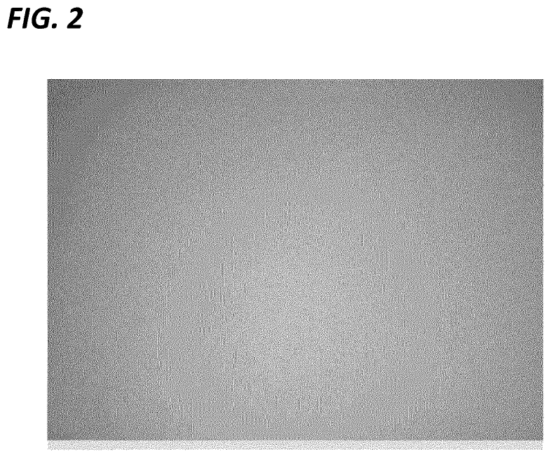

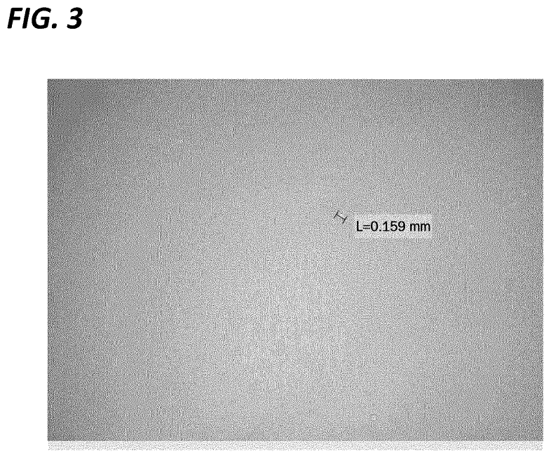

FIGS. 2 and 3 are microscopic images from which the presence or absence of separator protrusions was determined for Example 1 and Comparative Example 1 according to one embodiment of the present disclosure.

TABLE 1

| | | | | | | Comparative | Comparative | Comparative |
|---|---|---|---|---|---|---|---|---|
| | | Example 1 | Example 2 | Example 3 | Example 4 | Example 1 | Example 2 | Example 3 |
| Type of inorganic | | Boehmite | Alumina | Boehmite | Boehmite | Boehmite | Boehmite | Boehmite |
| material | | Polyether | Polyether | Polyether | Polyether | PAA | Polyether | CMC |
| Type of dispersant | | modified | modified | modified | modified | | modified | |
| | | styrene- | styrene- | styrene- | styrene- | | styrene- | |
| | | maleic | maleic | maleic | maleic | | maleic | |
| | | acid | acid | acid | acid | | acid | |
| Composition | D50 | 0.38 | 0.42 | 0.38 | 0.38 | 2.14 | 0.38 | 0.5 |
| particle size | D90 | 0.91 | 0.86 | 0.91 | 0.91 | 5.73 | 0.91 | 1.6 |
| (μm) | | | | | | | | |

| | | | | | | | |
|---|---|---|---|---|---|---|---|
| Thickness of | 1.5 | 1.5 | 2 | 3 | 2.2 | 4 | 1.5 |
| single-sided | | | | | | | |
| coating layer (μm) | | | | | | | |
| Thickness of | 3.0 | 3.0 | 4.0 | 6.0 | 4.4 | 8 | 3.0 |
| double-sided | | | | | | | |
| coating layer (μm) | | | | | | | |
| Resistance (Ohm) | 0.50 | 0.47 | 0.61 | 0.79 | 0.85 | 0.97 | 0.65 |
| Air permeability | 67 | 68 | 92 | 123 | 160 | 249 | 99 |
| (s/100 cc) | | | | | | | |
| Number of separator | 0 | 0 | 0 | 0 | 27 | 0 | 0 |
| protrusions (ea/m²) | | | | | | | |
| Number of non- | 0 | 0 | 0 | 0 | 0 | 0 | 42 |
| coated dots on | | | | | | | |
| separator surface | | | | | | | |
| (ea/m²) | | | | | | | |

According to Table 1, in the case of Examples 1 to 4 in which a dispersant containing a maleic acid monomer was used, it can be found that the composition particle size D90 may be adjusted to about 1.5 μm or less (e.g., about 1 μm or less), and the number of separator protrusions was not determined. Through this, it can be found that when the dispersant containing the maleic acid monomer is used, the coating properties of the coating layer become excellent, and the resistance and air permeability of the separator are improved.

In contrast, in the case of Comparative Example 1 in which a PAA-based dispersant was used instead of the maleic acid monomer-containing dispersant, it was found that the composition particle size D90 was 1.5 μm or more (e.g., 5.73 μm), and the number of separator protrusions was 27 ea/m². Then, it can be found that the agglomerated particles in the slurry with decreased dispersibility were formed into separator protrusions, and it can be seen that the resistance and air permeability value were also increased compared to Examples.

FIGS. 2 and 3 are microscopic images from which the presence or absence of separator protrusions was determined for Example 1 and Comparative Example 1.

According to FIG. 2, it can be found that in Example 1, the dispersibility in the coating layer was improved and thus no separator protrusions were observed.

According to FIG. 3, it was found that in Comparative Example 1, the dispersibility in the coating layer was decreased and thus separator protrusions were observed, and then the separator protrusion diameter (L) was 0.159 mm.

Although, like in Examples, the maleic acid monomer-containing dispersant was used in Comparative Example 2, it can be found that the resistance and air permeability value were increased compared to Examples because the thicknesses of the single-sided and double-sided coating layers were large, for example, 2.2 μm and 4.4 μm, respectively.

In Comparative Example 3, instead of the maleic acid monomer-containing dispersant, sodium carboxymethyl cellulose (CMC-Na) was used as for the dispersant. Then, it was found that the composition particle size D90 was high (1.6 μm) and the number of non-coated dots on the separator surface was 42 ea/m². Thus, it can be found that the dispersibility was decreased.

Therefore, in the coating layer composition according to one embodiment of the present disclosure, the separator using the same, and the electrochemical device including the same, since the dispersant included in the coating layer contains a maleic acid monomer, the dispersibility may be improved and the heat resistance properties may be improved.

In the foregoing, the present disclosure has been described in detail with reference to the drawings and embodiments. However, the embodiments described in this specification and the configurations illustrated in the drawings are merely exemplary embodiments of the present disclosure, and do not represent all the technical ideas of the present disclosure. Therefore, it should be understood that, at the time of filing, there may be various equivalents and modifications that could serve as alternatives to the embodiments.

### DESCRIPTION OF SYMBOLS

100: Separator for electrochemical device
110: Porous polymer substrate
130: Coating layer

1. A coating layer composition of a separator for an electrochemical device, the coating layer composition comprising:
inorganic particles, a polymer binder, and a dispersant,
wherein the dispersant includes a maleic acid monomer, and
wherein a particle size D50 of the coating layer composition is 0.3 μm to 1 μm.

2. The coating layer composition according to claim 1,
wherein a particle size D90 of the coating layer composition is 1.5 μm or less.

3. A separator for an electrochemical device comprising:
a porous polymer substrate; and
a coating layer provided on at least one surface of the porous polymer substrate, and including inorganic particles, a polymer binder, and a dispersant,
wherein the dispersant includes a maleic acid monomer, and
wherein a thickness of the coating layer is 1 μm to 3 μm.

4. (canceled)

5. The separator according to claim 3, wherein the inorganic particle is one selected from BaTiO₃, Pb(Zr,Ti)O₃ (PZT), Pb₁₋ₓLaₓZr_{1-y}Ti_{y}O₃ (PLZT, 0<x<1, 0<y<1), Pb(Mg_{1/3}Nb_{2/3})O₃—PbTiO₃ (PMN-PT), hafnia (HfO₂), SrTiO₃, SnO₂, CeO₂, MgO, Mg(OH)₂, NiO, CaO, ZnO, ZrO₂, SiO₂, Y₂O₃, SiC, Al₂O₃, Al(OH)₃, AlO(OH), TiO₂, zinctinhydroxide (ZnSn(OH)₆), tin-zinc oxide (Zn₂SnO₄, ZnSnO₃), antimony trioxide (Sb₂O₃), antimony tetroxide (Sb₂O₄), and antimony pentoxide (Sb₂O₅).

6. The separator according to claim 3, wherein an average particle size of the inorganic particles is 0.2 μm to 1.5 μm.

7. The separator according to claim 3, wherein the dispersant further includes a styrene monomer.

8. The separator according to claim 3, wherein the dispersant includes a styrene-maleic acid copolymer (SMA).

9. The separator according to claim 8, wherein the dispersant further includes a polyether chain.

10. The separator according to claim 3, wherein the coating layer further includes a surfactant, and
the surfactant is a polysiloxane-based material.

11. An electrochemical device comprising:
a positive electrode;
a negative electrode; and
the separator according to claim 3 interposed between the positive electrode and the negative electrode.

12. The electrochemical device according to claim 11, wherein the electrochemical device is a lithium secondary battery.
